(19) United States
(12) Patent Application Publication
(10) Pub. No.: US 2026/0030976 A1
(43) Pub. Date: Jan. 29, 2026

(54) TRAFFIC INFORMATION PROVIDING METHOD AND SYSTEM THEREFOR

(71) Applicant: HYUNDAI AUTOEVER CORP., Seoul (KR)

(72) Inventors: Mi Kyeong LEE, Seoul (KR); Ah Young KANG, Seoul (KR); Sang Kyu SON, Seoul (KR); Ru Da RHEE, Seoul (KR); Cheon Su AHN, Seoul (KR); Jeong Hun LEE, Seoul (KR); Woo Sun CHON, Seoul (KR); Han Seong RYU, Seoul (KR)

(21) Appl. No.: 19/278,048

(22) Filed: Jul. 23, 2025

(30) Foreign Application Priority Data
Jul. 23, 2024 (KR) 10-2024-0096993

(51) Int. Cl. G08G 1/01

(52) U.S. Cl. CPC G08G 1/0129; G08G 1/0112; G08G 1/0133; G08G 1/0145

(57) ABSTRACT

Traffic information providing methods and systems are described. According to one embodiment, the traffic information providing method includes inputting previously-generated multiple traffic pattern data and real-time traffic information into a traffic prediction model, outputting an error at a first time point for each of the previously-generated multiple traffic pattern data, and generating traffic information from a departure point to a destination using first traffic pattern data having a minimum error among the previously-generated multiple traffic pattern data, wherein each of the multiple traffic pattern data is a combination of pattern speeds per link, which is a minimum unit of a road.

### CROSS-REFERENCE TO RELATED APPLICATION

This application claims priority from Korean Patent Application No. 10-2024-0096993 filed on Jul. 23, 2024 in the Korean Intellectual Property Office, and all the benefits accruing therefrom under 35 U.S.C. 119, the contents of which in its entirety are herein incorporated by reference.

### FIELD

The present disclosure relates to a traffic information providing method and system, and more specifically, to a traffic information providing method and system capable of improving the accuracy of estimated time of arrival.

### BACKGROUND

In navigation services, it is important to accurately predict the estimated time of arrival. A navigation system calculates the estimated time of arrival from a departure point to a destination using real-time traffic information, such as driving speed in a specific section.

However, when the estimated time of arrival is calculated using only real-time traffic information, discrepancies frequently occur between the actual time of arrival and the estimated time of arrival.

Therefore, there is a need for a technique that reduces the error between the estimated time of arrival and the actual time of arrival.

### SUMMARY

An objective of the present disclosure is to provide a traffic information providing method and system capable of reducing the error between the estimated time of arrival and the actual time of arrival.

The objectives of the present disclosure are not limited to those mentioned above, and other objectives not explicitly stated will be clearly understood by those skilled in the art based on the following description.

According to an aspect of the present disclosure, a traffic information providing method performed by a computing system includes: inputting previously-generated multiple traffic pattern data and real-time traffic information into a traffic prediction model; outputting, as a result of the input, an error at a first time point for each of the multiple traffic pattern data; and generating traffic information from a departure point to a destination using first traffic pattern data having a minimum error among the multiple traffic pattern data, wherein each of the multiple traffic pattern data is a combination of pattern speeds per link, which is a minimum unit of a road.

The inputting of the multiple traffic pattern data may include: generating a route from the departure point to the destination; searching for a first tile to which a first link on the route belongs; and further inputting traffic volume of tiles adjacent to the first tile.

The further inputting of the traffic volume of the adjacent tiles may include calculating traffic volume for each of a second link and a third link having the same direction as the first link in the adjacent tiles, and the second and third links may belong to a second tile, which is one of the adjacent tiles.

The calculating of the traffic volume for each of the second and third links may include: calculating a first value by multiplying a number of probes that have passed through the second link by a length of the second link; calculating a second value by multiplying a number of probes that have passed through the third link by a length of the third link; and calculating a length-weighted average by dividing a sum of the first and second values by a sum of the lengths of the second and third links.

Each of the multiple traffic pattern data may be a combination of pattern speeds per link from a second time point preceding the first time point to a current time, the real-time traffic information may be a combination of real-time driving speeds per link from the second time point to the current time, and the outputting of the error at the first time point may include outputting a speed error per link at the first time point for each of the multiple traffic pattern data.

The generating of the traffic information may include generating traffic information from the departure point to the destination by combining, per link, traffic pattern data with a minimum speed error per link.

The generating of the traffic information may include generating traffic information from the departure point to the destination by applying second traffic pattern data having a maximum number of links with a minimum speed error per link, and the second traffic pattern data may be one of the multiple traffic pattern data.

According to another aspect of the present disclosure, a traffic information providing system includes: a communication interface; a memory in which a computer program is loaded; and at least one processor on which the computer program is executed, wherein the computer program includes instructions for performing operations of: inputting previously-generated multiple traffic pattern data and real-time traffic information into a traffic prediction model; outputting, as a result of the input, an error at a first time point for each of the multiple traffic pattern data; and generating traffic information from a departure point to a destination using first traffic pattern data having a minimum error among the multiple traffic pattern data, and each of the multiple traffic pattern data is a combination of pattern speeds per link, which is a minimum unit of a road.

The inputting of the multiple traffic pattern data may include: generating a route from the departure point to the destination; searching for a first tile to which a first link on the route belongs; and further inputting traffic volume of tiles adjacent to the first tile.

The further inputting of the traffic volume of the adjacent tiles may include calculating traffic volume for each of a second link and a third link having the same direction as the first link in the adjacent tiles, and the second and third links may belong to a second tile, which is one of the adjacent tiles.

The calculating of the traffic volume for each of the second and third links may include: calculating a first value by multiplying a number of probes that have passed through the second link by a length of the second link; calculating a second value by multiplying a number of probes that have passed through the third link by a length of the third link; and calculating a length-weighted average by dividing a sum of the first and second values by a sum of the lengths of the second and third links.

Each of the multiple traffic pattern data may be a combination of pattern speeds per link from a second time point preceding the first time point to a current time, the real-time traffic information may be a combination of real-time driving speeds per link from the second time point to the current time, and the outputting of the error at the first time point may include outputting a speed error per link at the first time point for each of the multiple traffic pattern data.

The generating of the traffic information may include generating traffic information from the departure point to the destination by combining, per link, traffic pattern data with a minimum speed error per link.

The generating of the traffic information may include generating traffic information from the departure point to the destination by applying second traffic pattern data having a maximum number of links with a minimum speed error per link, and the second traffic pattern data may be one of the multiple traffic pattern data.

According to another aspect of the present disclosure, a computer-readable recording medium stores a computer program that, when executed in conjunction with a computing device, causes the computing device to: input previously-generated multiple traffic pattern data and real-time traffic information into a traffic prediction model; output, as a result of the input, an error at a first time point for each of the multiple traffic pattern data; and generate traffic information from a departure point to a destination using first traffic pattern data having a minimum error among the multiple traffic pattern data, wherein each of the multiple traffic pattern data is a combination of pattern speeds per link, which is a minimum unit of a road.

### BRIEF DESCRIPTION OF THE DRAWINGS

The above and other aspects and features of the present disclosure will become more apparent by describing exemplary embodiments thereof in detail with reference to the attached drawings, in which:

FIG. 1 is a block diagram illustrating a traffic information generation system according to an embodiment of the present disclosure;

FIG. 2 is a flowchart illustrating a traffic information providing method according to another embodiment of the present disclosure;

FIG. 3 is a detailed flowchart illustrating step S100 of the traffic information providing method of FIG. 2;

FIG. 4 is a diagram illustrating adjacent tiles, which may be referenced in some embodiments of the present disclosure;

FIG. 5 is a diagram illustrating a method for inputting traffic volume of adjacent tiles, which may be performed in some embodiments of the present disclosure;

FIG. 6 is a detailed flowchart illustrating step S130 of the traffic information providing method of FIG. 3; and

FIG. 7 is a block diagram illustrating the hardware configuration of a computing system according to some embodiments of the present disclosure.

### DETAILED DESCRIPTION

Hereinafter, preferred embodiments of the present disclosure will be described in detail with reference to the accompanying drawings. The advantages and features of the present disclosure, and methods for achieving them, will become apparent by reference to the embodiments described in detail below in conjunction with the accompanying drawings. However, the technical spirit of the present disclosure is not limited to the following embodiments and may be implemented in various forms. The following embodiments are merely provided to fully disclose the technical spirit of the present disclosure and to fully convey the scope of the present disclosure to those skilled in the art, and the technical spirit of the present disclosure is defined only by the scope of the claims.

In describing the present disclosure, specific descriptions of well-known components or functions are omitted when it is determined that such descriptions may unnecessarily obscure the gist of the present invention.

Unless otherwise defined, terms (including technical and scientific terms) used in the following embodiments may be used in a sense commonly understood by one of ordinary skill in the art to which the present disclosure pertains. However, the meanings of such terms may vary depending on the intention of a technician in the relevant field, legal precedent, the emergence of new technology, or other factors. The terms used in the present disclosure are for the purpose of describing embodiments and are not intended to limit the scope of the present disclosure.

In the following embodiments, singular expressions may include plural concepts unless clearly specified as singular from the context. Likewise, plural expressions may include singular concepts unless clearly specified as plural from the context.

Also, in the following embodiments, terms such as first, second, A, B, (a), and (b) are used merely to distinguish one component from another, and such terms do not limit the nature, order, or sequence of the corresponding components.

Various embodiments of the present disclosure will hereinafter be described with reference to the accompanying drawings.

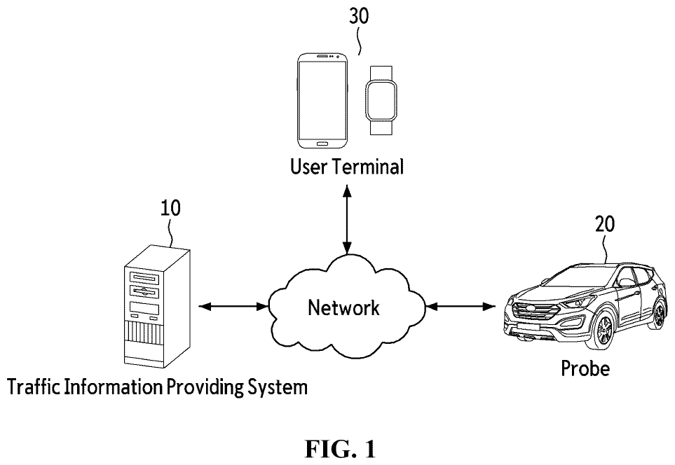

The configuration and operation of a traffic information generation system according to an embodiment of the present disclosure will hereinafter be described with reference to FIG. 1. FIG. 1 is a block diagram illustrating a traffic information generation system according to an embodiment of the present disclosure.

Referring to FIG. 1, the traffic information generation system may include a traffic information providing system 10, a probe 20, and a user terminal 30, but the present disclosure is not limited thereto. In some embodiments, the traffic information generation system may be configured to further include modules, devices, or systems not illustrated in FIG. 1. Alternatively, the traffic information generation system may be configured with at least some of the traffic information providing system 10, the probe 20, and the user terminal 30 in FIG. 1 omitted.

The user terminal 30 may be a device that provides a navigation service. For example, the user terminal 30 may be a navigation system mounted on a mobility device of a user, such as the probe 20. Alternatively, the user terminal 30 may be a portable device of a user that provides a navigation service. The user terminal 30 may track the GPS position of the probe 20 and transmit the tracked GPS position to the traffic information providing system 10.

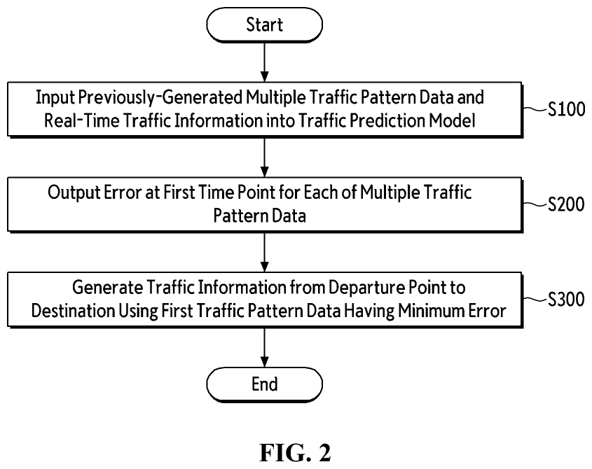

The traffic information providing system 10 may input multiple traffic pattern data and real-time traffic information into a traffic prediction model and output, as a result of the input, an error at a future time point for each of the multiple traffic pattern data. In addition, the traffic information providing system 10 may receive the GPS position of the probe 20 from the user terminal 30 and calculate the traffic volume of adjacent tiles using the received GPS position. The traffic information providing system 10 may input the calculated traffic volume of the adjacent tiles into the traffic prediction model and output, as a result of the output, an error at a future time point for each of the multiple traffic pattern data. As a result, the error at a future time point for each of the multiple traffic pattern data may be further reduced. The method of outputting the traffic volume of adjacent tiles and the error at a future time point for each of the multiple traffic pattern data will be described later in detail with reference to FIGS. 2 through 6.

The traffic information providing system 10 may select first traffic pattern data having a minimum error among the multiple traffic pattern data and calculate traffic information, such as the estimated time of arrival, from a departure point to a destination using the first traffic pattern data.

In the following description, for the sake of clarity, it is assumed that all steps/operations of methods to be described below are performed by the traffic information providing system 10. Therefore, when the subject of a specific step/operation is omitted, the specific step/operation may be understood to be performed by the traffic information providing system 10. However, in actual environments, some steps/operations of the methods to be described below may be performed by other computing devices.

A traffic information providing method according to an embodiment of the present disclosure will hereinafter be described with reference to FIG. 2. FIG. 2 is a flowchart illustrating a traffic information providing method according to an embodiment of the present disclosure.

Referring to FIG. 2, the traffic information providing system 10 may input previously-generated multiple traffic pattern data and real-time traffic information into a traffic prediction model (S100). Each of the multiple traffic pattern data may be a combination of pattern speeds per link, which is the minimum unit of a road. A link is the minimum unit obtained by dividing a road into sections. One of ordinary skill in the art to which the present disclosure pertains may be familiar with this, and thus, a detailed description thereof will be omitted. The multiple traffic pattern data may be data obtained by combining speeds under specific conditions for each link.

The multiple traffic pattern data may be generated for respective traffic flow concepts. For example, the multiple traffic pattern data may be traffic flow data corresponding to cases where traffic flow is slow, normal, and fast. In addition, the multiple traffic pattern data may be traffic flow data different from usual conditions. For example, the multiple traffic pattern data may represent traffic flow in the morning of a national holiday. The multiple traffic pattern data may also be traffic flow data generated by inputting specific conditions into an artificial intelligence (AI) model.

The real-time traffic information may be data regarding real-time traffic flow and may be a combination of real-time driving speeds per link.

Thereafter, the traffic information providing system 10 may output, as a result of the input in step S100, an error at a first time point for each of the input multiple traffic pattern data (S200). The traffic prediction model is a model that compares each of the multiple traffic pattern data with the real-time traffic information and predicts an error at the first time point in the future. In the present disclosure, the traffic prediction model refers to an AI-based model, and may also be referred to simply as a model or AI model for predicting traffic information.

The error at the first time point may be an error between a pattern speed per link and a real-time driving speed per link. That is, the error at the first time point may refer to an error between the pattern speed per link included in traffic pattern data for past traffic flow and the real-time driving speed per link included in the real-time traffic information. The error at the first time point may be calculated using mean absolute error (MAE) or mean squared error (MSE).

For example, the traffic information providing system 10 may input traffic pattern data and real-time traffic information from the past hour into the traffic prediction model and output an error in driving speed per link for traffic conditions three hours later, which corresponds to the first time point in the future.

Thereafter, the traffic information providing system 10 may generate traffic information from the departure point to the destination using first traffic pattern data having a minimum error at the first time point among the multiple traffic pattern data (S300). The traffic information may include information such as the estimated time of arrival and route from the departure point to the destination.

According to this embodiment, the traffic information providing system 10 may compare traffic pattern data including a past driving speed per link with real-time traffic information including a real-time driving speed per link using an AI model and may select first traffic pattern data having a minimum error in the driving speed per link as a result of the comparison. In this case, the traffic information providing system 10 may provide more accurate traffic information by generating traffic information such as the estimated time of arrival using the first traffic pattern data.

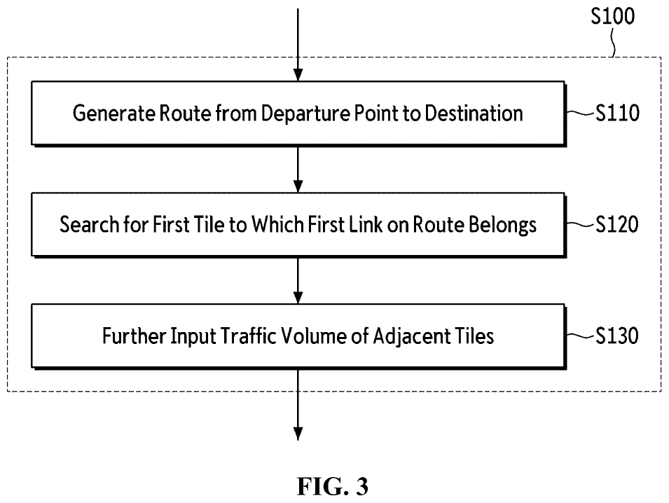

A method for inputting traffic volume of adjacent tiles according to an embodiment of the present disclosure will hereinafter be described with reference to FIG. 3. FIG. 3 is a detailed flowchart illustrating step S100 of the traffic information providing method of FIG. 2.

Referring to FIG. 3, the traffic information providing system 10 may generate a route from a departure point to a destination (S110). In some embodiments, a plurality of routes may be generated. The route may be composed of a combination of links.

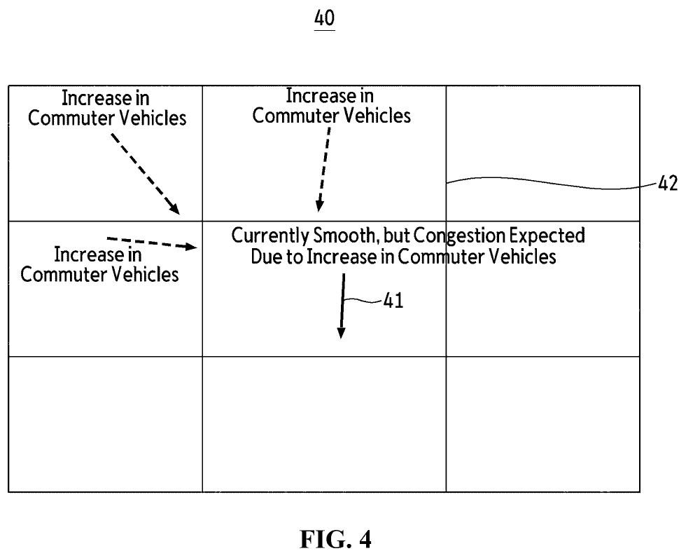

Thereafter, the traffic information providing system 10 may search for a first tile to which a first link on the route belongs. The concept of a tile will hereinafter be described with reference to FIG. 4. FIG. 4 is a diagram illustrating adjacent tiles, which may be referenced in some embodiments of the present disclosure.

FIG. 4 illustrates map data 40. The map data 40 may represent a route from a departure point to a destination. A first link 41 in the map data 40 may belong to a first tile 42. That is, a tile may be a sector obtained by partitioning the map data 40 into a fixed size. A tile may include links on the route from the departure point to the destination. The traffic information providing system 10 may additionally input the traffic volume of tiles adjacent to the tile to which a given link belongs into a traffic prediction model in order to output an error between traffic pattern data and real-time traffic information for the given link. Referring to FIG. 4, the traffic information providing system 10 may additionally input the traffic volume of eight tiles adjacent to the first tile 42, to which the first link 41 belongs, into the traffic prediction model in order to output the error between the traffic pattern data and the real-time traffic information for the first link 41.

To calculate the error at a first time point, which is a future time point, for the first link 41 with respect to each of multiple traffic pattern data, the traffic information providing system 10 may input, as the traffic volume of the adjacent tiles, a situation in the adjacent tiles, for example, data indicating that vehicles are increasing in the adjacent tiles during rush hour. As a result, when calculating the error at the first time point for the first link 41 with respect to each of the multiple traffic pattern data, it is possible to refer to traffic conditions over a wider area. Therefore, by additionally inputting the traffic volume of the adjacent tiles, the error can be more effectively reduced.

Thereafter, referring again to FIG. 3, the traffic information providing system 10 may further input the traffic volume of tiles adjacent to and in contact with the first tile into the traffic prediction model (S130). The adjacent tiles may be tiles that share at least one point with the first tile.

According to this embodiment, when comparing the multiple traffic pattern data and real-time traffic information and calculating, as a result of the comparison, the error at a future time point for each of the multiple traffic pattern data, the error at the future time point can be more effectively reduced by additionally inputting the traffic volume of the adjacent tiles. Therefore, according to this embodiment, the most similar traffic pattern data to traffic conditions at a specific future time point can be selected from past traffic pattern data, and the traffic conditions at the future time point can be predicted based on the selected traffic pattern data, thus enabling more accurate traffic information to be provided to the user.

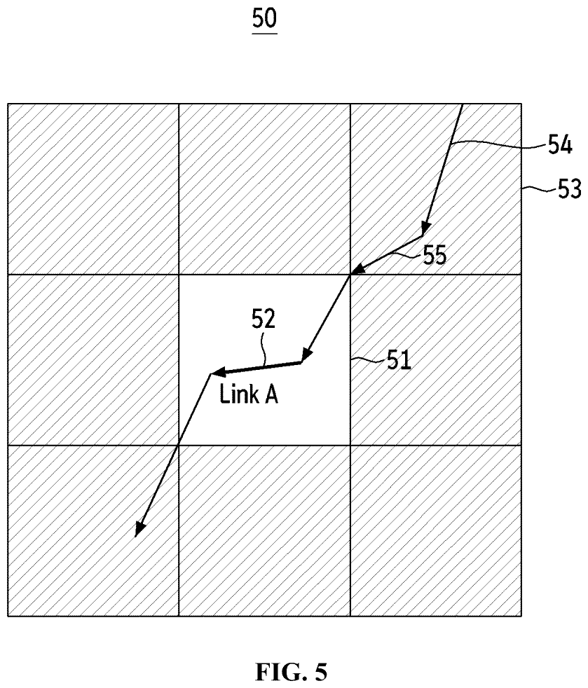

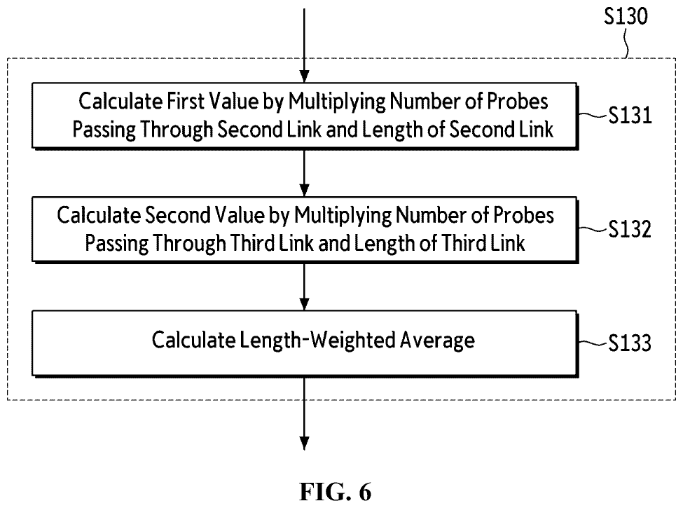

A method for inputting traffic volume of adjacent tiles according to an embodiment of the present disclosure will hereinafter be described with reference to FIGS. 5 and 6. FIG. 5 is a diagram illustrating a method for inputting traffic volume of adjacent tiles, which may be performed in some embodiments of the present disclosure. FIG. 6 is a detailed flowchart illustrating step S130 of the traffic information providing method of FIG. 3.

FIG. 5 illustrates map data 50 abstracted from actual map data. The map data 50 shows a first link 52, which is a target link for which the error at the first time point, which is a future time point, is to be output, a first tile 51 to which the first link 52 belongs, a second tile 53 that is adjacent to the first tile 51, and a second link 54 and a third link 55 that belong to the second tile 53.

The traffic information providing system 10 may calculate the traffic volume for each of the second and third links 54 and 55, which are in the second tile 52 adjacent to the first tile 51 and have the same direction as the first link 52. The direction of each link may be assigned based on a predetermined criterion. For example, the direction of a link may be determined as either an upward or downward direction. In the present disclosure, it is assumed that the first, second, and third links 52, 54, and 55 all have the same direction.

Referring to FIG. 6, the traffic information providing system 10 may calculate a first value by multiplying the number of probes that have passed through the second link 54 by the length of the second link 54 (S131). The number of probes 20 that have passed through the second link 54 may refer to the number of probes 20 that have passed through the second link 54 during a past unit time based on the current time. For example, the number of probes 20 that have passed through the second link 54 may be the number of probes 20 that have passed through the second link 54 over the past hour from the current time. The traffic information providing system 10 may acquire the number of probes 20 that have passed through the second link 54 by receiving information from the respective user terminals 30 indicating whether the probes 20 have passed through the second link 54.

Thereafter, the traffic information providing system 10 may calculate a second value by multiplying the number of probes 20 that have passed through the third link 55 by the length of the third link 55 (S132). Since step S132 is performed in the same manner as step S131, a detailed description of step S132 will be omitted for convenience of understanding.

Thereafter, the traffic information providing system 10 may calculate a length-weighted average by dividing the sum of the first and second values by the sum of the lengths of the second and third links 54 and 55 (S133). That is, the traffic information providing system 10 may calculate a weighted average based on the number of probes 20 that have passed through each link and the length of each link, and input the calculated weighted average into the traffic prediction model as the traffic volume of the adjacent tiles.

According to this embodiment, by additionally inputting the traffic volume of adjacent tiles along with multiple traffic pattern data and real-time traffic information, it is possible to refer to data on traffic flow in a wider area and more accurately predict the error at a future time point for each of the multiple traffic pattern data.

Meanwhile, in one embodiment, each of the multiple traffic pattern data input into the traffic prediction model may be a combination of pattern speeds per link from a second time point, which is also a future time point preceding the first time point, to the current time, and the real-time traffic information may be a combination of real-time driving speeds per link from the second time point to the current time.

In this case, the traffic information providing system 10 may input the multiple traffic pattern data and the real-time traffic information into the traffic prediction model and output a speed error per link at the first time point for each of the multiple traffic pattern data.

That is, the traffic information providing system 10 may input the multiple traffic pattern data and the real-time traffic information per link into the traffic prediction model and output, per link, an error at a future time point for each of the multiple traffic pattern data.

Meanwhile, the traffic information providing system 10 may generate traffic information from the departure point to the destination by combining, per link, traffic pattern data with a minimum speed error per link. For example, if the traffic information providing system 10 predicts that the first traffic pattern data has the minimum error at the first time point for the first link, and second traffic pattern data has the minimum error at the first time point for the second link, the traffic information providing system 10 may apply the first traffic pattern data to the first link and the second traffic pattern data to the second link to calculate traffic information such as the estimated time of arrival.

Alternatively, the traffic information providing system 10 may generate traffic information from the departure point to the destination by applying the second traffic pattern data that has the maximum number of links with the minimum speed error per link. In this case, the second traffic pattern data may be selected as one of the multiple traffic pattern data. For example, if the total number of links nationwide is seven million, the traffic information providing system 10 predicts the first traffic pattern data as having the minimum error at the first time point for two million links, and the second traffic pattern data as having the minimum error for five million links. In this case, the traffic information providing system 10 may generate traffic information such as the estimated time of arrival and route from the departure point to the destination by applying the second traffic pattern data, which is predicted to have the minimum error at the first time point for five million links.

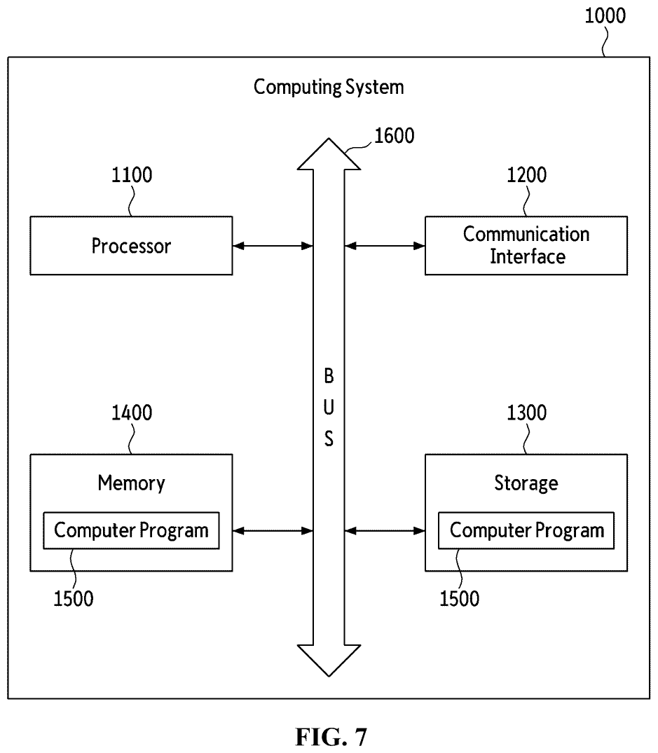

FIG. 7 is a block diagram illustrating the hardware configuration of a computing system according to some embodiments of the present disclosure. Referring to FIG. 7, a computing system 1000 may include at least one processor 1100, a system bus 1600, a communication interface 1200, a memory 1400 for loading a computer program 1500 executed by the processor 1100, and a storage 1300 for storing the computer program 1500.

The computing system 1000 of FIG. 7 may represent, for example, the hardware structure of one or more computing systems constituting the traffic information providing system 10 described with reference to FIG. 1.

The processor 1100 controls the overall operation of each component of the computing system 1000. The processor 1100 may perform computations for at least one application or program for executing methods/operations according to various embodiments of the present disclosure. The memory 1400 stores various types of data, commands, and/or information. The memory 1400 may load one or more computer programs 1500 from the storage 1300 in order to execute the methods/operations according to various embodiments of the present disclosure. The storage 1300 may non-transitorily store one or more computer programs 1500.

The computer program 1500 may include one or more instructions in which the methods/operations according to various embodiments of the present disclosure are implemented. When the computer program 1500 is loaded into the memory 1400, the processor 1100 may execute the one or more instructions to perform the methods/operations according to various embodiments of the present disclosure.

In one embodiment, the computer program 1500 may include instructions for performing the operations of: inputting previously-generated multiple traffic pattern data and real-time traffic information into a traffic prediction model; outputting, as a result of the input, an error at a first time point for each of the multiple traffic pattern data; and generating traffic information from a departure point to a destination using first traffic pattern data with a minimum error among the multiple traffic pattern data. Each of the multiple traffic pattern data may be a combination of pattern speeds per link, which is the minimum unit of a road.

Up to this point, various embodiments of the present disclosure and the effects thereof have been described with reference to FIGS. 1 through 7. The effects of the technical spirit of the present disclosure are not limited to the effects mentioned above, and other effects not mentioned may be clearly understood by one of ordinary skill in the art from the following description. In addition, although in the above embodiments, multiple components have been

described as being combined or operating in combination, the technical spirit of the present disclosure is not necessarily limited to such embodiments. That is, within the intended scope of the technical spirit of the present disclosure, all components may be selectively combined and operated in one or more ways.

The technical spirit of the present disclosure described above may be implemented as computer-readable code on a computer-readable medium. A computer program recorded on a computer-readable recording medium may be transmitted to another computing device via a network such as the Internet and installed on the other computing device, and thus used on that other computing device.

What is claimed is:

1. A traffic information providing method performed by a computing system, the traffic information providing method comprising:
inputting previously-generated multiple traffic pattern data and real-time traffic information into a traffic prediction model;
outputting an error at a first time point for each of the previously-generated multiple traffic pattern data; and
generating traffic information from a departure point to a destination using first traffic pattern data having a minimum error among the previously-generated multiple traffic pattern data,
wherein each of the previously-generated multiple traffic pattern data is a combination of pattern speeds per link, which is a minimum unit of a road.

2. The traffic information providing method of claim 1, wherein the inputting of the previously-generated multiple traffic pattern data comprises:
generating a route from the departure point to the destination;
searching for a first tile to which a first link on the route belongs; and
further inputting traffic volume of tiles adjacent to the first tile.

3. The traffic information providing method of claim 2, wherein
the further inputting of the traffic volume of tiles adjacent to the first tile comprises calculating traffic volume for each of a second link and a third link having a same direction as the first link in the tiles adjacent to the first tile, and
wherein the second link and the third link belong to a second tile, which is one of the tiles adjacent to the first tile.

4. The traffic information providing method of claim 3, wherein the calculating of the traffic volume for each of the second link and the third link comprises:
calculating a first value by multiplying a number of probes that have passed through the second link by a length of the second link;
calculating a second value by multiplying a number of probes that have passed through the third link by a length of the third link; and
calculating a length-weighted average by dividing a sum of the first value and the second value by a sum of the length of the second link and the third link.

5. The traffic information providing method of claim 1, wherein
the each of the previously-generated multiple traffic pattern data is the combination of pattern speeds per link from a second time point preceding the first time point to a current time,
the real-time traffic information is a combination of real-time driving speeds per link from the second time point to the current time, and
the outputting of the error at the first time point comprises outputting a speed error per link at the first time point for the each of the previously-generated multiple traffic pattern data.

6. The traffic information providing method of claim 5, wherein the generating of the traffic information comprises generating traffic information from the departure point to the destination by combining, per link, traffic pattern data with a minimum speed error per link.

7. The traffic information providing method of claim 6, wherein
the generating of the traffic information comprises generating the traffic information from the departure point to the destination by applying second traffic pattern data having a maximum number of links with the minimum speed error per link, and
the second traffic pattern data is one of the previously-generated multiple traffic pattern data.

8. A traffic information providing system comprising:
a communication interface;
a memory in which a computer program is loaded; and
at least one processor on which the computer program is executed,
wherein
the computer program includes instructions for performing operations of: inputting previously-generated multiple traffic pattern data and real-time traffic information into a traffic prediction model; outputting an error at a first time point for each of the previously-generated multiple traffic pattern data; and generating traffic information from a departure point to a destination using first traffic pattern data having a minimum error among the previously-generated multiple traffic pattern data, and
each of the previously-generated multiple traffic pattern data is a combination of pattern speeds per link, which is a minimum unit of a road.

9. The traffic information providing system of claim 8, wherein the inputting of the previously-generated multiple traffic pattern data comprises:
generating a route from the departure point to the destination;
searching for a first tile to which a first link on the route belongs; and
further inputting traffic volume of tiles adjacent to the first tile.

10. The traffic information providing system of claim 9, wherein
the further inputting of the traffic volume of tiles adjacent to the first tile comprises calculating traffic volume for each of a second link and a third link having a same direction as the first link in the tiles adjacent to the first tile, and
the second link and third link belong to a second tile, which is one of the tiles adjacent to the first tile.

11. The traffic information providing system of claim 10, wherein the calculating of the traffic volume for each of the second link and the third link comprises:
calculating a first value by multiplying a number of probes that have passed through the second link by a length of the second link;
calculating a second value by multiplying a number of probes that have passed through the third link by a length of the third link; and
calculating a length-weighted average by dividing a sum of the first value and the second value by a sum of the lengths of the second link and the third link.

12. The traffic information providing system of claim 8, wherein
the each of the previously-generated multiple traffic pattern data is the combination of pattern speeds per link from a second time point preceding the first time point to a current time,
the real-time traffic information is a combination of real-time driving speeds per link from the second time point to the current time, and
the outputting of the error at the first time point comprises outputting a speed error per link at the first time point for each of the previously-generated multiple traffic pattern data.

13. The traffic information providing system of claim 12, wherein the generating of the traffic information comprises generating traffic information from the departure point to the destination by combining, per link, traffic pattern data with a minimum speed error per link.

14. The traffic information providing system of claim 12, wherein
the generating of the traffic information comprises generating traffic information from the departure point to the destination by applying second traffic pattern data having a maximum number of links with a minimum speed error per link, and
the second traffic pattern data is one of the previously-generated multiple traffic pattern data.

15. A computer-readable recording medium storing a computer program that, when executed in conjunction with a computing device, causes the computing device to: input previously-generated multiple traffic pattern data and real-time traffic information into a traffic prediction model; output an error at a first time point for each of the previously-generated multiple traffic pattern data; and generate traffic information from a departure point to a destination using first traffic pattern data having a minimum error among the previously-generated multiple traffic pattern data,
wherein each of the previously-generated multiple traffic pattern data is a combination of pattern speeds per link, which is a minimum unit of a road.
